(19) United States
(12) Patent Application Publication
(10) Pub. No.: US 2025/0175680 A1
(43) Pub. Date: May 29, 2025

(54) INFORMATION EXCHANGE METHOD, ELECTRONIC DEVICE AND STORAGE MEDIUM

(71) Applicant: Beijing Zitiao Network Technology Co., Ltd., Beijing (CN)

(72) Inventors: Baolei BAI, Beijing (CN); Xiang LI, Beijing (CN); Longlong ZHANG, Beijing (CN); Qi HUANG, Beijing (CN); Yang YANG, Beijing (CN)

(21) Appl. No.: 18/840,895

(22) PCT Filed: Jun. 8, 2023
(86) PCT No.: PCT/CN2023/099052

§ 371 Date: Aug. 22, 2024

(30) Foreign Application Priority Data
Jul. 18, 2022 (CN) 202210844086.0

(51) Int. Cl. H04N 21/81; G06T 17/00; H04N 21/2187

(52) U.S. Cl. CPC H04N 21/816; G06T 17/00; H04N 21/2187

(57) ABSTRACT

An information exchange method, an electronic device, and a storage medium are provided. The method includes: receiving composite video configuration information, wherein the composite video configuration information comprises virtual reality space information, at least one piece of virtual reality subspace information corresponding to the virtual reality space information, and video configuration information corresponding to the virtual reality subspace information; determining a target virtual reality subspace in which a user is located in a virtual reality space; and determining, based on the composite video configuration information, video configuration information corresponding to the target virtual reality subspace, and presenting video content in the target virtual reality subspace based on the determined video configuration information.

### CROSS-REFERENCE TO RELATED APPLICATION

The present application is filed based on and claims priority to Chinese Patent Application No. 202210844086.0, filed on Jul. 18, 2022, and entitled “INFORMATION EXCHANGE METHOD AND APPARATUS, ELECTRONIC DEVICE, AND STORAGE MEDIUM”, which is incorporated herein by reference in its entirety.

### TECHNICAL FIELD

The present disclosure relates to the field of computer technologies, and in particular, to an information exchange method and apparatus, an electronic device, and a storage medium.

### BACKGROUND

With the development of virtual reality (VR) technology, an increasing number of virtual live-streaming platforms or applications have been developed for use by users. In the virtual live-streaming platforms, a user can watch live video streaming through, for example, a head-mounted display device and related accessories. However, a single form of virtual live video streaming is provided in the related art, which causes poor user experience.

### SUMMARY

The Summary is provided to give a brief overview of concepts, which will be described in detail later in the section Detailed Description of the Invention. The Summary is neither intended to identify key or necessary features of the claimed technical solutions, nor is it intended to be used to limit the scope of the claimed technical solutions.

In a first aspect, according to one or more embodiments of the present disclosure, there is provided an information exchange method. The method includes:
receiving composite video configuration information, where the composite video configuration information includes virtual reality space information, at least one piece of virtual reality subspace information corresponding to the virtual reality space information, and video configuration information corresponding to the virtual reality subspace information;
determining a target virtual reality subspace in which a user is located in a virtual reality space; and
determining, based on the composite video configuration information, video configuration information corresponding to the target virtual reality subspace, and presenting video content in the target virtual reality subspace based on the determined video configuration information.

In a second aspect, according to one or more embodiments of the present disclosure, there is provided an information exchange apparatus. The apparatus includes:
an information receiving unit configured to receive composite video configuration information, where the composite video configuration information includes virtual reality space information, at least one piece of virtual reality subspace information corresponding to the virtual reality space information, and video configuration information corresponding to the virtual reality subspace information;
a subspace determining unit configured to determine a target virtual reality subspace in which a user is located in a virtual reality space; and
a display unit configured to determine, based on the composite video configuration information, video configuration information corresponding to the target virtual reality subspace, and present video content in the target virtual reality subspace based on the determined video configuration information.

In a third aspect, according to one or more embodiments of the present disclosure, there is provided an electronic device, including at least one memory and at least one processor. The memory is configured to store program code. The processor is configured to call the program code stored in the memory, to cause the electronic device to perform the information exchange method according to one or more embodiments of the present disclosure.

In a fourth aspect, according to one or more embodiments of the present disclosure, there is provided a non-transitory computer storage medium storing program code that, when executed by a computer device, causes the computer device to perform the information exchange method according to one or more embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic diagram of a virtual reality device according to an embodiment of the present disclosure;

FIG. 2 is an optional schematic diagram of a virtual field of view of a virtual reality device according to an embodiment of the present disclosure;

FIG. 3 is a flowchart of an information exchange method according to an embodiment of the present disclosure;

FIG. 4 is a schematic diagram of a virtual reality space according to an embodiment of the present disclosure; and

FIG. 5 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the steps described in implementations of the present disclosure may be performed in different orders, and/or performed in parallel. Furthermore, additional steps may be included and/or the execution of the illustrated steps may be omitted in the implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. The term “in response to” and a related term mean that a signal or event is affected by another signal or event to an extent, but is not necessarily fully or directly affected. If an event x occurs “in response to” an event y, x may respond directly or indirectly to y. For example, the occurrence of y may finally lead to the occurrence of x, but there may be other intermediate events and/or conditions. In other situations, the occurrence of y may not necessarily lead to the occurrence of x, that is, even if y has not occurred, x may occur. Moreover, the term “in response to” may also mean “at least partially in response to”.

The term “determine” broadly encompasses a wide variety of actions, which may include obtaining, computing, calculating, processing, deriving, investigating, looking up (for example, looking up in a sheet, a database, or other data structures), ascertaining, or similar actions, and may further include receiving (for example, receiving information), accessing (for example, accessing data in a memory), or similar actions, and parsing, selecting, choosing, establishing, and similar actions, and the like. Related definitions of the other terms will be given in the description below. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

For the purpose of the present disclosure, the phrase “A and/or B” means (A), (B), or (A and B).

The names of messages or information exchanged between a plurality of apparatuses in the implementations of the present disclosure are used for illustrative purposes only, and are not used to limit the scope of these messages or information.

An information exchange method according to one or more embodiments of the present disclosure employs an extended reality (XR for short) technology. The extended reality technology can combine reality with virtuality through a computer to provide a user with a virtual reality space that allows for human-computer interaction. In the virtual reality space, the user may implement social interaction, entertainment, learning, working, telecommuting, creation of user generated content (UGC), etc., via the virtual reality device such as a head mount display (HMD).

The virtual reality device described in the embodiments of the present disclosure may include, but is not limited to, the following types:
a personal computer virtual reality (PCVR) device which performs computation related to a virtual reality function and data output by using a PC, where an external personal computer virtual reality device achieves virtual reality effects by using data output by the PC;
a mobile virtual reality device which supports setting of a mobile terminal (for example, a smartphone) in various manners (for example, a head-mounted display provided with a special slot), and is connected to the mobile terminal in a wired or wireless manner, where the mobile terminal performs computation related to a virtual reality function, and outputs data to the mobile virtual reality device, for example, a virtual reality video is watched through an APP in the mobile terminal; and
an integrated virtual reality device which has a processor configured to perform computation related to a virtual function, and therefore has an independent virtual reality input and output function, with no need to be connected to a PC or a mobile terminal, providing a high degree of freedom of use.

Of course, an implementation form of the virtual reality device is not limited thereto, and the device may be further miniaturized or enlarged as needed.

A posture detection sensor (for example, a nine-axis sensor) is provided in the virtual reality device for detecting a posture change of the virtual reality device in real time. If the user wears the virtual reality device, a real-time posture of the head of the user is transmitted to a processor when a posture of the head changes, so as to calculate a fixation point of a line of sight of the user in a virtual environment, and calculate an image in a fixation range of the user (i.e., a virtual field of view) in a three-dimensional model of the virtual environment based on the fixation point. The image is displayed on a display screen, providing immersive experience that the user feels like watching in the real environment.

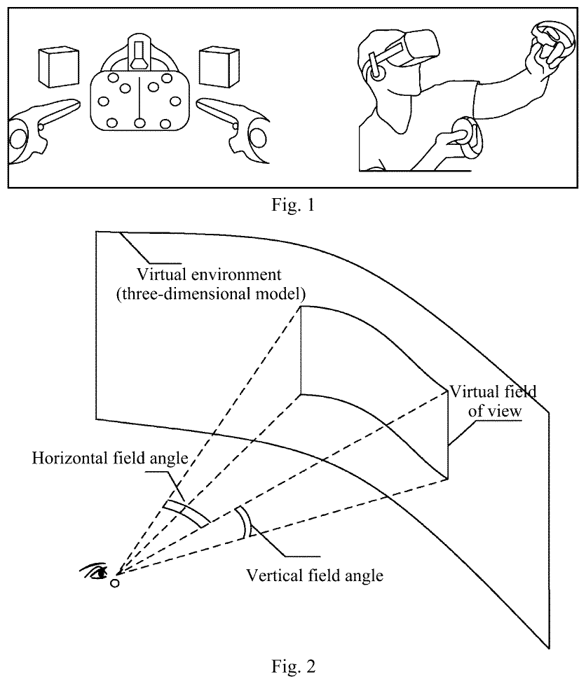

FIG. 2 is an optional schematic diagram of a virtual field of view of a virtual reality device according to an embodiment of the present disclosure. A distribution range of the virtual field of view in the virtual environment is described using a horizontal field angle and a vertical field angle, where the distribution range in a vertical direction is represented by the vertical field angle BOC, and the distribution range in a horizontal direction is represented by the horizontal field angle AOB, such that a human eye is always able to perceive, through a lens, an image in the virtual environment that is located in the virtual field of view. It can be understood that a larger field angle means a larger virtual field of view, which allows the user to perceive a larger region of the virtual environment. The field angle represents a distribution range of a viewing angle formed when the environment is perceived through the lens. For example, a field angle of the virtual reality device represents a distribution range of a viewing angle of the human eye formed when the virtual environment is perceived through a lens of the virtual reality device. For another example, for a mobile terminal provided with a camera, a field angle of the camera is a distribution range of a viewing angle formed when the camera perceives a real environment for shooting.

The virtual reality device, such as an HMD, is integrated with a number of cameras (for example, a depth camera, an RGB camera, etc.), which are not limited to providing pass-through views. A camera image and an integrated inertial measurement unit (IMU) provide data that may be processed by a computer vision method to automatically analyze and understand the environment. In addition, the HMD is designed to support not only passive computer vision analysis but also active computer vision analysis. In passive computer vision methods, image information captured from the environment is analyzed. The methods may be monoscopic (images from a single camera) or stereoscopic (images from two cameras). The methods include, but are not limited to, feature tracking, object recognition, and depth estimation. In active computer vision methods, information is added to the environment by projecting patterns that are visible to the camera but not necessarily visible to a human visual system. Such techniques include a time-of-flight (ToF) camera, laser scanning, or structured light to simplify the stereo matching problem. Active computer vision is used for implementing scene depth reconstruction.

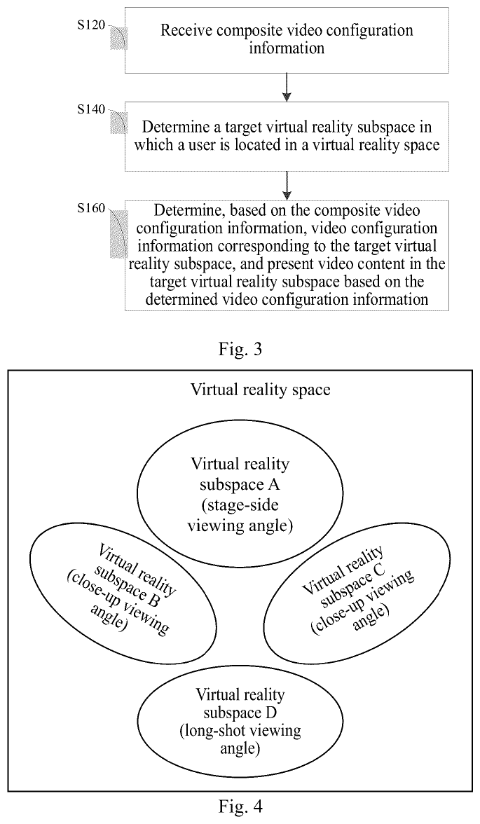

Referring to FIG. 3, FIG. 3 is a flowchart of an information exchange method 100 according to an embodiment of the present disclosure. The method 100 includes step S120 to step S160.

Step S120: Receive composite video configuration information, where the composite video configuration information includes virtual reality space information, at least one piece of virtual reality subspace information corresponding to the virtual reality space information, and video configuration information corresponding to the virtual reality subspace information.

In some embodiments, the virtual reality space information is used to identify content presented by a virtual reality space. For example, taking a live video streaming as an example, the virtual reality space information may be a name of a live video streaming scene. For example, if a virtual live-streaming space is configured to live stream a program A, virtual reality space information corresponding to the virtual live-streaming space may be “the program A”.

In a specific implementation, a corresponding virtual reality space may be pre-configured at a server for video content to be played (e.g., the program A). The virtual reality space may have more than two virtual reality subspaces, each of which may be configured with one or more video streams. Videos displayed in different virtual reality subspaces may provide different video viewing angles for a same object (e.g., a same program), such as a stage-side viewing angle, a close-up viewing angle, and a long-shot viewing angle. After the configuration is completed, the server may deliver, to a client, virtual reality space information (such as a scene name and a scene ID) corresponding to the virtual reality space, information about a quantity of virtual reality subspaces that the virtual reality space has, and video configuration information corresponding to each virtual reality subspace.

In some embodiments, after the server delivers the composite video configuration information to the client, the client may convert the composite video configuration information to a preset standard format. In this embodiment, the client converts the received composite video configuration information to the preset standard format in a uniform manner, so that the client may be compatible with and adapted to composite video configuration information of different formats or versions.

In some embodiments, the video configuration information includes video presentation mode information, and the video presentation mode information includes one or more pieces of the following: screen shape information, screen quantity information, video dimension type information, and virtual camera information.

For example, the video presentation mode information may be used to describe a quantity of screens configured to present a video in the virtual reality subspace, a shape of each screen, a video dimension type (either a 3D video or a 2D video) corresponding to each screen, and the virtual camera information. The 3D video may include, but is not limited to, a rectangular 3D video, a semi-panoramic 3D video, a panoramic 3D video, or a fisheye 3D video. A virtual camera is a tool configured to simulate a viewing angle and a field of view at which a user can see in a virtual reality environment. The virtual camera information includes, but is not limited to, a focal length, an imaging angle, a spatial position, etc.

In some embodiments, the video configuration information includes video stream information. For example, coding formats such as H.265, H.264, and MPEG-4 may be used for a video stream.

In some embodiments, the virtual reality space may be a simulated environment of a real world, a semi-simulated and semi-fictional virtual scene, or a purely fictional virtual scene. The virtual scene may be any one of a two-dimensional virtual scene, a 2.5-dimensional virtual scene, or a three-dimensional virtual scene. A dimensionality of the virtual scene is not limited in this embodiment of this application. For example, the virtual scene may include sky, land, and sea, and the land may include environmental elements such as a desert and a city. The user may control a virtual object to move in the virtual scene.

Referring to FIG. 1, the user may enter the virtual reality space via an intelligent terminal device such as head-mounted VR glasses, and control his/her own virtual character (Avatar) in the virtual reality space to implement social interaction with virtual characters controlled by other users, entertainment, learning, telecommuting, etc.

In an embodiment, the user may implement a related interactive operation in the virtual reality space via a controller, where the controller may be a gamepad. For example, the user may perform related operation control through an operation on a button of the gamepad. Of course, in another embodiment, a target object in a virtual reality device may be controlled by a gesture, speech, or multimodal control rather than a controller.

In some embodiments, the virtual reality space includes a virtual live-streaming space. In the virtual live-streaming space, a viewing user may control a virtual character (Avatar) to watch a live-streaming video of a performing user from a viewing angle such as a first-person view or a third-person view.

Step S140: Determine a target virtual reality subspace in which the user is located in the virtual reality space.

In some embodiments, the target virtual reality subspace in which the user is located in the virtual reality space is determined in response to an instruction triggered by the user to enable a virtual character controlled by the user to enter the target virtual reality subspace.

For example, the user may control the virtual character to move in the virtual reality subspace, and a preset instruction may be used to enable the virtual character controlled by the user to switch between different virtual reality subspaces.

In a specific implementation, a transfer point may be set in each virtual reality subspace. When the user controls the virtual character to approach or touch a transfer point, the virtual character is transferred into a target virtual reality subspace corresponding to the transfer point.

Step S160: Determine, based on the composite video configuration information, video configuration information corresponding to the target virtual reality subspace, and present video content in the target virtual reality subspace based on the determined video configuration information.

For example, when the user controls the virtual character to enter a virtual reality subspace B from a virtual reality subspace A, the client may perform video rendering based on pre-received video configuration information corresponding to the virtual reality subspace B, so as to present, to the user, video content provided in the virtual reality subspace B.

In some embodiments, a video presentation mode corresponding to the target virtual subspace, such as a quantity of screens, a shape of the screen, and a video dimension type (such as a 3D video or a 2D video) corresponding to the screen, may be determined based on the video configuration information corresponding to the target virtual subspace, to further create a corresponding screen and render a video in the target virtual subspace.

According to one or more embodiments of the present disclosure, the composite video configuration information is received, where the composite video configuration information includes the virtual reality space information, the at least one piece of virtual reality subspace information corresponding to the virtual reality space information, and the video configuration information corresponding to the virtual reality subspace information, so that the video configuration information corresponding to the target virtual reality subspace can be determined based on the received composite video configuration information, and the corresponding video content can be presented in the target virtual reality subspace. Therefore, a variety of video presentation scenes can be built on the client, providing rich and diverse viewing experience to the user.

In some embodiments, videos displayed in different virtual reality subspaces in a same virtual reality space may provide different video viewing angles, such as a stage-side viewing angle, a close-up viewing angle, and a long-shot viewing angle, for a same object (e.g., a same program).

For example, live streaming of a gala in the virtual reality space is used as an example for illustration. Referring to FIG. 4, a virtual reality subspace A corresponding to the stage-side viewing angle, virtual reality subspaces B and C corresponding to the close-up viewing angle, and a virtual reality subspace D corresponding to the long-shot viewing angle may be set in the virtual reality space. Accordingly, when the user controls the virtual character to enter the virtual reality subspace A, a gala picture shot from a stage may be viewed in the virtual reality subspace A; when the user controls the virtual character to enter the virtual reality subspace B or C, a gala picture shot nearby the stage may be viewed in the virtual reality subspace B or C; and when the user controls the virtual character to enter the virtual reality subspace D, a gala picture shot far away from the stage may be viewed in the virtual reality subspace D. Therefore, the user can view from different viewing angles according to their own needs, to obtain real live viewing experience in the virtual reality space. In a specific implementation, the virtual reality subspace A may be located in a stage area set in the virtual reality space, and the virtual reality subspaces B, C, and D may be located in an audience area set in the virtual reality space.

In a specific implementation, video streams corresponding to different virtual reality subspaces can provide video content captured by camera apparatuses at different shooting angles or shooting positions.

In some embodiments, a same virtual reality subspace corresponds to two or more than two pieces of video configuration information. For example, one primary screen and a plurality of secondary screens may be set in one virtual reality subspace. The primary screen and the secondary screens may correspond to different video streams, different screen shapes, and different video dimension types. For example, a 3D panoramic video may be played on the primary screen, and a 2D video may be played on the secondary screens.

In some embodiments, primary screens in different virtual reality subspaces may be configured to present video content of different viewing angles, and secondary screens in different virtual reality subspaces may be configured to present video content of a same viewing angle.

In some embodiments, different video presentation environments may be presented in different virtual reality spaces, and the video presentation environment includes one or more of the following: a stage, setting, lighting, props, special effect elements, and choreography. For example, different video content, such as different program content, different live-streamers, and different galas, may be played through different virtual reality spaces, and different virtual reality spaces have different stage sets, lighting designs, animation special effects, etc.

In a specific implementation, different animation resources (such as a sticker, an animation model, and light and shadow special effects) for presenting video presentation environments may be configured for different virtual reality spaces. The animation resource may be pre-stored in the client for rendering a corresponding video presentation environment after the user enters a virtual reality space.

In some embodiments, the video configuration information includes live-streaming phase information, and the live-streaming phase information includes one or more of the following: a pre-live-streaming phase, an in-live-streaming phase, and a post-live-streaming phase. For example, different stage sets, lighting designs, and animation special effects may be presented in the virtual reality space in different live-streaming phases, providing rich viewing experience to the user.

Accordingly, according to an embodiment of the present disclosure, there is provided an information exchange apparatus, including:
an information receiving unit configured to receive composite video configuration information, where the composite video configuration information includes virtual reality space information, at least one piece of virtual reality subspace information corresponding to the virtual reality space information, and video configuration information corresponding to the virtual reality subspace information;
a subspace determining unit configured to determine a target virtual reality subspace in which a user is located in a virtual reality space; and
a display unit configured to determine, based on the composite video configuration information, video configuration information corresponding to the target virtual reality subspace, and present video content in the target virtual reality subspace based on the determined video configuration information.

In some embodiments, video configuration information corresponding to different virtual reality subspaces in a same virtual reality space is capable of providing different viewing angles for a same object.

In some embodiments, the viewing angle includes one or more of the following: a stage-side viewing angle, a close-up viewing angle, and a long-shot viewing angle.

In some embodiments, a same virtual reality subspace corresponds to two or more than two pieces of video configuration information.

In some embodiments, the two or more than two pieces of video configuration information include video configuration information for presenting a 3D video image and video configuration information for presenting a 2D video image.

In some embodiments, different video presentation environments are presented in different virtual reality spaces, and the video presentation environment includes one or more of the following elements: a stage, setting, lighting, props, special effect elements, and choreography.

In some embodiments, the virtual reality space information includes a scene identifier.

In some embodiments, the video configuration information includes video presentation mode information, and the video presentation mode information includes one or more pieces of the following: screen shape information, screen quantity information, video dimension type information, and virtual camera information.

In some embodiments, the video configuration information includes live-streaming phase information, and the live-streaming phase information includes one or more of the following: a pre-live-streaming phase, an in-live-streaming phase, and a post-live-streaming phase.

In some embodiments, the subspace determining unit is configured to determine, in response to an instruction triggered by the user to enable a virtual character controlled by the user to enter the target virtual reality subspace, the target virtual reality subspace in which the user is located in the virtual reality space.

The apparatus embodiment is substantially corresponding to the method embodiment, and therefore for a related part, reference may be made to the descriptions of the part in the method embodiment. The apparatus embodiment described above is only illustrative, and the modules described as separate modules therein may or may not be separate. Some or all of the modules may be selected according to actual needs to achieve the objectives of the solutions of the embodiments, which can be understood and implemented by those of ordinary skill in the art without involving any inventive effort.

Accordingly, according to one or more embodiments of the present disclosure, there is provided an electronic device, including:
at least one memory and at least one processor.

The memory is configured to store program code. The processor is configured to call the program code stored in the memory, to cause the electronic device to perform the information exchange method according to one or more embodiments of the present disclosure.

Accordingly, according to one or more embodiments of the present disclosure, there is provided a non-transitory computer storage medium storing program code that is executable by a computer device to cause the computer device to perform the information exchange method according to one or more embodiments of the present disclosure.

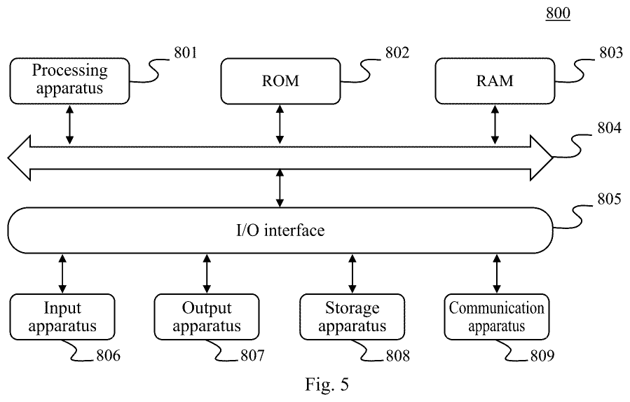

Referring to FIG. 5 below, there is shown a schematic diagram of a structure of an electronic device (such as a terminal device or a server) 800 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 800 may include a processing apparatus (e.g., a central processing unit or a graphics processing unit) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 5 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 809 and installed, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the above method according to the present disclosure.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, there is provided an information exchange method. The method includes: receiving composite video configuration information, where the composite video configuration information includes virtual reality space information, at least one piece of virtual reality subspace information corresponding to the virtual reality space information, and video configuration information corresponding to the virtual reality subspace information; determining a target virtual reality subspace in which a user is located in a virtual reality space; and determining, based on the composite video configuration information, video configuration information corresponding to the target virtual reality subspace, and presenting video content in the target virtual reality subspace based on the determined video configuration information.

According to one or more embodiments of the present disclosure, video configuration information corresponding to different virtual reality subspaces in a same virtual reality space is capable of providing different viewing angles for a same object.

According to one or more embodiments of the present disclosure, the viewing angle includes one or more of the following: a stage-side viewing angle, a close-up viewing angle, and a long-shot viewing angle.

According to one or more embodiments of the present disclosure, a same virtual reality subspace corresponds to two or more than two pieces of video configuration information.

According to one or more embodiments of the present disclosure, the two or more than two pieces of video configuration information include video configuration information for presenting a 3D video image and video configuration information for presenting a 2D video image.

According to one or more embodiments of the present disclosure, different video presentation environments are presented in different virtual reality spaces, and the video presentation environment includes one or more of the following elements: a stage, setting, lighting, props, special effect elements, and choreography.

According to one or more embodiments of the present disclosure, the virtual reality space information includes a scene identifier.

According to one or more embodiments of the present disclosure, the video configuration information includes video presentation mode information, and the video presentation mode information includes one or more pieces of the following: screen shape information, screen quantity information, video dimension type information, and virtual camera information.

According to one or more embodiments of the present disclosure, the video configuration information includes live-streaming phase information, and the live-streaming phase information includes one or more of the following: a pre-live-streaming phase, an in-live-streaming phase, and a post-live-streaming phase.

According to one or more embodiments of the present disclosure, the determining a target virtual reality subspace in which a user is located in a virtual reality space includes: determining, in response to an instruction triggered by the user to enable a virtual character controlled by the user to enter the target virtual reality subspace, the target virtual reality subspace in which the user is located in the virtual reality space.

According to one or more embodiments of the present disclosure, there is provided an information exchange apparatus. The apparatus includes: an information receiving unit configured to receive composite video configuration information, where the composite video configuration information includes virtual reality space information, at least one piece of virtual reality subspace information corresponding to the virtual reality space information, and video configuration information corresponding to the virtual reality subspace information; a subspace determining unit configured to determine a target virtual reality subspace in which a user is located in a virtual reality space; and a display unit configured to determine, based on the composite video configuration information, video configuration information corresponding to the target virtual reality subspace, and present video content in the target virtual reality subspace based on the determined video configuration information.

According to one or more embodiments of the present disclosure, there is provided an electronic device, including at least one memory and at least one processor. The memory is configured to store program code. The processor is configured to call the program code stored in the memory, to cause the electronic device to perform the information exchange method according to one or more embodiments of the present disclosure.

According to one or more embodiments of the present disclosure, there is provided a non-transitory computer storage medium storing program code that, when executed by a computer device, causes the computer device to perform the information exchange method according to one or more embodiments of the present disclosure.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An information exchange method, comprising:
receiving composite video configuration information, wherein the composite video configuration information comprises virtual reality space information, at least one piece of virtual reality subspace information corresponding to the virtual reality space information, and video configuration information corresponding to the virtual reality subspace information;
determining a target virtual reality subspace in which a user is located in a virtual reality space; and
determining, based on the composite video configuration information, video configuration information corresponding to the target virtual reality subspace, and presenting video content in the target virtual reality subspace based on the determined video configuration information.

2. The method according to claim 1, wherein video configuration information corresponding to different virtual reality subspaces in a same virtual reality space is capable of providing different viewing angles for a same object.

3. The method according to claim 2, wherein the viewing angle comprises one or more of the following: a stage-side viewing angle, a close-up viewing angle, and a long-shot viewing angle.

4. The method according to claim 1, wherein a same virtual reality subspace corresponds to two or more than two pieces of video configuration information.

5. The method according to claim 4, wherein the two or more than two pieces of video configuration information comprise video configuration information for presenting a 3D video image and video configuration information for presenting a 2D video image.

6. The method according to claim 1, wherein different video presentation environments are presented in different virtual reality spaces, and the video presentation environment comprises one or more of the following elements: a stage, setting, lighting, props, special effect elements, and choreography.

7. The method according to claim 1, wherein the virtual reality space information comprises a scene identifier.

8. The method according to claim 1, wherein the video configuration information comprises video presentation mode information, and the video presentation mode information comprises one or more pieces of the following: screen shape information, screen quantity information, video dimension type information, and virtual camera information.

9. The method according to claim 1, wherein the video configuration information comprises live-streaming phase information, and the live-streaming phase information comprises one or more of the following: a pre-live-streaming phase, an in-live-streaming phase, and a post-live-streaming phase.

10. The method according to claim 1, wherein the determining a target virtual reality subspace in which a user is located in a virtual reality space comprises:
determining, in response to an instruction triggered by the user to enable a virtual character controlled by the user to enter the target virtual reality subspace, the target virtual reality subspace in which the user is located in the virtual reality space.

11. (canceled)

12. An electronic device, comprising:
at least one memory and at least one processor,
wherein the at least one memory is configured to store program code, and the at least one processor is configured to call the program code stored in the memory, to cause the electronic device to perform an information exchange method, which comprises:
receiving composite video configuration information, wherein the composite video configuration information comprises virtual reality space information, at least one piece of virtual reality subspace information corresponding to the virtual reality space information, and video configuration information corresponding to the virtual reality subspace information;
determining a target virtual reality subspace in which a user is located in a virtual reality space; and
determining, based on the composite video configuration information, video configuration information corresponding to the target virtual reality subspace, and presenting video content in the target virtual reality subspace based on the determined video configuration information.

13. A non-transitory computer storage medium,
storing program code that, when executed by a computer device, causes the computer device to perform an information exchange method, which comprises:
receiving composite video configuration information, wherein the composite video configuration information comprises virtual reality space information, at least one piece of virtual reality subspace information corresponding to the virtual reality space information, and video configuration information corresponding to the virtual reality subspace information;
determining a target virtual reality subspace in which a user is located in a virtual reality space; and
determining, based on the composite video configuration information, video configuration information corresponding to the target virtual reality subspace, and presenting video content in the target virtual reality subspace based on the determined video configuration information.

14. The electronic device according to claim 12, wherein video configuration information corresponding to different virtual reality subspaces in a same virtual reality space is capable of providing different viewing angles for a same object.

15. The electronic device according to claim 14, wherein the viewing angle comprises one or more of the following: a stage-side viewing angle, a close-up viewing angle, and a long-shot viewing angle.

16. The electronic device according to claim 12, wherein a same virtual reality subspace corresponds to two or more than two pieces of video configuration information.

17. The electronic device according to claim 16, wherein the two or more than two pieces of video configuration information comprise video configuration information for presenting a 3D video image and video configuration information for presenting a 2D video image.

18. The electronic device according to claim 12, wherein different video presentation environments are presented in different virtual reality spaces, and the video presentation environment comprises one or more of the following elements: a stage, setting, lighting, props, special effect elements, and choreography.

19. The electronic device according to claim 12, wherein the virtual reality space information comprises a scene identifier.

20. The electronic device according to claim 12, wherein the video configuration information comprises video presentation mode information, and the video presentation mode information comprises one or more pieces of the following: screen shape information, screen quantity information, video dimension type information, and virtual camera information.

21. The electronic device according to claim 12, wherein the video configuration information comprises live-streaming phase information, and the live-streaming phase information comprises one or more of the following: a pre-live-streaming phase, an in-live-streaming phase, and a post-live-streaming phase.
